(19) United States
(12) Patent Application Publication
(10) Pub. No.: US 2026/0019955 A1
(43) Pub. Date: Jan. 15, 2026

(54) POWER CONTROL DETERMINATION FOR NON-UNIFORM BIT DISTRIBUTIONS

(71) Applicant: QUALCOMM Incorporated, San Diego, CA (US)

(72) Inventors: Pinar SEN, San Diego, CA (US); Wei YANG, San Diego, CA (US); Kirill IVANOV, La Jolla, CA (US); Jing JIANG, San Diego, CA (US); Akash Sandeep DOSHI, SAN DIEGO, CA (US); June NAMGOONG, San Diego, CA (US); Taesang YOO, San Diego, CA (US); Tingfang JI, San Diego, CA (US)

(21) Appl. No.: 18/773,241

(22) Filed: Jul. 15, 2024

(51) Int. Cl. H04W 52/24; H04L 5/00; H04W 52/22

(52) U.S. Cl. CPC H04W 52/242; H04L 5/0048; H04W 52/225

(57) ABSTRACT

Methods, systems, and devices for wireless communications at a user equipment (UE) or other wireless device are described. The UE may communicate bit distribution information for an uncompressed message set, the uncompressed message set including a plurality of messages and the bit distribution information indicating a distribution of bits included in one or more messages of the plurality of messages of the uncompressed message set. The UE may transmit, at a transmit power determined in accordance with a bits per resource element (BPRE) parameter, a first message from the plurality of messages of the uncompressed message set, where the BPRE parameter is a function of the bit distribution information for the uncompressed message set and a quantity of resource elements utilized for transmission of the first message.

### FIELD OF TECHNOLOGY

The following relates to wireless communications, including power control determination for non-uniform bit distributions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may perform power control operations. However, such approaches may be improved.

### SUMMARY

The systems, methods, and devices of this disclosure each have several innovative aspects, no single one of which is solely responsible for the desirable attributes disclosed herein.

A method for wireless communications by a wireless device is described. The method may include communicating bit distribution information for an uncompressed message set, the uncompressed message set including a set of multiple messages and the bit distribution information indicating a distribution of bits included in one or more messages of the set of multiple messages of the uncompressed message set and transmitting, at a transmit power determined in accordance with a bits per resource element (BPRE) parameter, a first message from the set of multiple messages of the uncompressed message set, where the BPRE parameter is a function of the bit distribution information for the uncompressed message set and a quantity of resource elements utilized for transmission of the first message.

A wireless device for wireless communications is described. The wireless device may include one or more memories storing processor executable code, and one or more processors coupled with the one or more memories. The one or more processors may individually or collectively be operable to execute the code to cause the wireless device to communicate bit distribution information for an uncompressed message set, the uncompressed message set including a set of multiple messages and the bit distribution information indicating a distribution of bits included in one or more messages of the set of multiple messages of the uncompressed message set and transmit, at a transmit power determined in accordance with a bits per resource element (BPRE) parameter, a first message from the set of multiple messages of the uncompressed message set, where the BPRE parameter is a function of the bit distribution information for the uncompressed message set and a quantity of resource elements utilized for transmission of the first message.

Another wireless device for wireless communications is described. The wireless device may include means for communicating bit distribution information for an uncompressed message set, the uncompressed message set including a set of multiple messages and the bit distribution information indicating a distribution of bits included in one or more messages of the set of multiple messages of the uncompressed message set and means for transmitting, at a transmit power determined in accordance with a bits per resource element (BPRE) parameter, a first message from the set of multiple messages of the uncompressed message set, where the BPRE parameter is a function of the bit distribution information for the uncompressed message set and a quantity of resource elements utilized for transmission of the first message.

A non-transitory computer-readable medium storing code for wireless communications is described. The code may include instructions executable by one or more processors to communicate bit distribution information for an uncompressed message set, the uncompressed message set including a set of multiple messages and the bit distribution information indicating a distribution of bits included in one or more messages of the set of multiple messages of the uncompressed message set and transmit, at a transmit power determined in accordance with a bits per resource element (BPRE) parameter, a first message from the set of multiple messages of the uncompressed message set, where the BPRE parameter is a function of the bit distribution information for the uncompressed message set and a quantity of resource elements utilized for transmission of the first message.

In some examples of the method, wireless devices, and non-transitory computer-readable medium described herein, the BPRE parameter may be associated with a transmit power adjustment parameter of a transmit power calculation that determines the transmit power for transmission of the first message.

In some examples of the method, wireless devices, and non-transitory computer-readable medium described herein, the bit distribution information includes entropy information associated with the uncompressed message set.

In some examples of the method, wireless devices, and non-transitory computer-readable medium described herein, the entropy information includes an average entropy for the set of multiple messages of the uncompressed message set.

In some examples of the method, wireless devices, and non-transitory computer-readable medium described herein, the entropy information may be based on a marginal distribution of bits of one or more messages from the uncompressed message set or a joint distribution of bits of one or more messages from the uncompressed message set.

Some examples of the method, wireless devices, and non-transitory computer-readable medium described herein may further include operations, features, means, or instructions for receiving an indication designating the entropy information as marginal distribution information or joint distribution information.

Some examples of the method, wireless devices, and non-transitory computer-readable medium described herein may further include operations, features, means, or instructions for transmitting a demodulation reference signal associated with the first message, where the first message and the demodulation reference signal may be each transmitted at the transmit power.

In some examples of the method, wireless devices, and non-transitory computer-readable medium described herein, the bit distribution information includes probability information associated with a quantity of bits of the first message.

In some examples of the method, wireless devices, and non-transitory computer-readable medium described herein, a power scaling of the transmit power may be inversely proportional to a logarithmic function of the probability information.

In some examples of the method, wireless devices, and non-transitory computer-readable medium described herein, the BPRE parameter may be based on a power scaling parameter associated with the first message.

In some examples of the method, wireless devices, and non-transitory computer-readable medium described herein, communicating the bit distribution information may include operations, features, means, or instructions for receiving the probability information and receiving a parameter for calculating the probability information, the parameter including an indication of a marginal probability of occurrence of bits associated with the first message and correlation information.

In some examples of the method, wireless devices, and non-transitory computer-readable medium described herein, the transmit power may be specific to the first message and a second transmit power of a reference signal may be based on an average entropy of the uncompressed message set.

In some examples of the method, wireless devices, and non-transitory computer-readable medium described herein, the BPRE parameter may be based on a quantity of cyclic redundancy check bits associated with the first message.

A method for wireless communications by a wireless device is described. The method may include communicating bit distribution information for an uncompressed message set, the uncompressed message set including a set of multiple messages and the bit distribution information indicating a distribution of bits included in one or more messages of the set of multiple messages of the uncompressed message set and receiving a first message from the set of multiple messages of the uncompressed message set, the first message communicated at a transmit power determined in accordance with a bits per resource element (BPRE) parameter, where the BPRE parameter is a function of the bit distribution information for the uncompressed message set and a quantity of resource elements utilized for transmission of the first message.

A wireless device for wireless communications is described. The wireless device may include one or more memories storing processor executable code, and one or more processors coupled with the one or more memories. The one or more processors may individually or collectively be operable to execute the code to cause the wireless device to communicate bit distribution information for an uncompressed message set, the uncompressed message set including a set of multiple messages and the bit distribution information indicating a distribution of bits included in one or more messages of the set of multiple messages of the uncompressed message set and receive a first message from the set of multiple messages of the uncompressed message set, the first message communicated at a transmit power determined in accordance with a bits per resource element (BPRE) parameter, where the BPRE parameter is a function of the bit distribution information for the uncompressed message set and a quantity of resource elements utilized for transmission of the first message.

Another wireless device for wireless communications is described. The wireless device may include means for communicating bit distribution information for an uncompressed message set, the uncompressed message set including a set of multiple messages and the bit distribution information indicating a distribution of bits included in one or more messages of the set of multiple messages of the uncompressed message set and means for receiving a first message from the set of multiple messages of the uncompressed message set, the first message communicated at a transmit power determined in accordance with a bits per resource element (BPRE) parameter, where the BPRE parameter is a function of the bit distribution information for the uncompressed message set and a quantity of resource elements utilized for transmission of the first message.

A non-transitory computer-readable medium storing code for wireless communications is described. The code may include instructions executable by one or more processors to communicate bit distribution information for an uncompressed message set, the uncompressed message set including a set of multiple messages and the bit distribution information indicating a distribution of bits included in one or more messages of the set of multiple messages of the uncompressed message set and receive a first message from the set of multiple messages of the uncompressed message set, the first message communicated at a transmit power determined in accordance with a bits per resource element (BPRE) parameter, where the BPRE parameter is a function of the bit distribution information for the uncompressed message set and a quantity of resource elements utilized for transmission of the first message.

In some examples of the method, wireless devices, and non-transitory computer-readable medium described herein, the BPRE parameter may be associated with a transmit power adjustment parameter of a transmit power calculation that determines the transmit power for transmission of the first message.

In some examples of the method, wireless devices, and non-transitory computer-readable medium described herein, the bit distribution information includes entropy information associated with the uncompressed message set.

In some examples of the method, wireless devices, and non-transitory computer-readable medium described herein, the entropy information includes an average entropy for the set of multiple messages of the uncompressed message set.

In some examples of the method, wireless devices, and non-transitory computer-readable medium described herein, the entropy information may be based on a marginal distribution of bits of one or more messages from the uncompressed message set or a joint distribution of bits of one or more messages from the uncompressed message set.

Some examples of the method, wireless devices, and non-transitory computer-readable medium described herein may further include operations, features, means, or instructions for transmitting an indication designating the entropy information as marginal distribution information or joint distribution information.

Some examples of the method, wireless devices, and non-transitory computer-readable medium described herein may further include operations, features, means, or instructions for receiving a demodulation reference signal associated with the first message, where the first message and the demodulation reference signal may be each transmitted at the transmit power.

In some examples of the method, wireless devices, and non-transitory computer-readable medium described herein, the bit distribution information includes probability information associated with a quantity of bits of the first message.

In some examples of the method, wireless devices, and non-transitory computer-readable medium described herein, a power scaling of the transmit power may be inversely proportional to a logarithmic function of the probability information.

In some examples of the method, wireless devices, and non-transitory computer-readable medium described herein, the BPRE parameter may be based on a power scaling parameter associated with the first message.

In some examples of the method, wireless devices, and non-transitory computer-readable medium described herein, communicating the bit distribution information may include operations, features, means, or instructions for transmitting the probability information and transmitting a parameter for calculating the probability information, the parameter including an indication of a marginal probability of occurrence of bits associated with the first message and correlation information.

In some examples of the method, wireless devices, and non-transitory computer-readable medium described herein, the transmit power may be specific to the first message and a second transmit power of a reference signal may be based on an average entropy of the uncompressed message set.

In some examples of the method, wireless devices, and non-transitory computer-readable medium described herein, the BPRE parameter may be based on a quantity of cyclic redundancy check bits associated with the first message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports power control determination for non-uniform bit distributions in accordance with one or more examples as disclosed herein.

FIG. 2 shows an example of a wireless communications system that supports power control determination for non-uniform bit distributions in accordance with one or more examples as disclosed herein.

FIG. 3 shows an example of a process flow that supports power control determination for non-uniform bit distributions in accordance with one or more examples as disclosed herein.

FIGS. 4 and 5 show block diagrams of devices that support power control determination for non-uniform bit distributions in accordance with one or more examples as disclosed herein.

FIG. 6 shows a block diagram of a communications manager that supports power control determination for non-uniform bit distributions in accordance with one or more examples as disclosed herein.

FIG. 7 shows a diagram of a system including a device that supports power control determination for non-uniform bit distributions in accordance with one or more examples as disclosed herein.

FIGS. 8 and 9 show block diagrams of devices that support power control determination for non-uniform bit distributions in accordance with one or more examples as disclosed herein.

FIG. 10 shows a block diagram of a communications manager that supports power control determination for non-uniform bit distributions in accordance with one or more examples as disclosed herein.

FIG. 11 shows a diagram of a system including a device that supports power control determination for non-uniform bit distributions in accordance with one or more examples as disclosed herein.

FIGS. 12 and 13 show flowcharts illustrating methods that support power control determination for non-uniform bit distributions in accordance with one or more examples as disclosed herein.

### DETAILED DESCRIPTION

In wireless communications, power control techniques are used throughout various operations, including uplink transmissions. For example, power control techniques may allocate enough power to transmit the uplink signal without unnecessarily draining power from a user equipment (UE) or causing too much interference to other devices. However, in some approaches, such power control may assume a uniform distribution (e.g., an independent and identically distributed (IID) distribution) of binary bit values, even though some scenarios may not have such uniform distributions (e.g., due to redundancy, strong memory, dummy bits, or other non-uniformities).

Techniques for power control determinations for non-uniform bit distributions may be employed. For example, a UE may determine one or more values for a bits per resource element (BPRE) parameter (e.g., corresponding to a spectral efficiency of a transmission) based on bit distribution information that is associated with a message to be transmitted (e.g., an uplink message, downlink message, sidelink message, or other messaging). In some examples, the bit distribution information may be based on entropy information of a set of messages (e.g., that includes the message to be transmitted) or message-specific probability information associated with the message to be transmitted. In at least these ways, communications quality, throughput, power utilization, flexibility, and reliability may be increased while reducing overhead, latency, and excess power expenditures.

Aspects of the disclosure are initially described in the context of wireless communications systems. Aspects of the disclosure are then described with reference to a wireless communications system and a process flow. Aspects of the disclosure are further illustrated by and described with reference to apparatus diagrams, system diagrams, and flowcharts that relate to power control determination for non-uniform bit distributions.

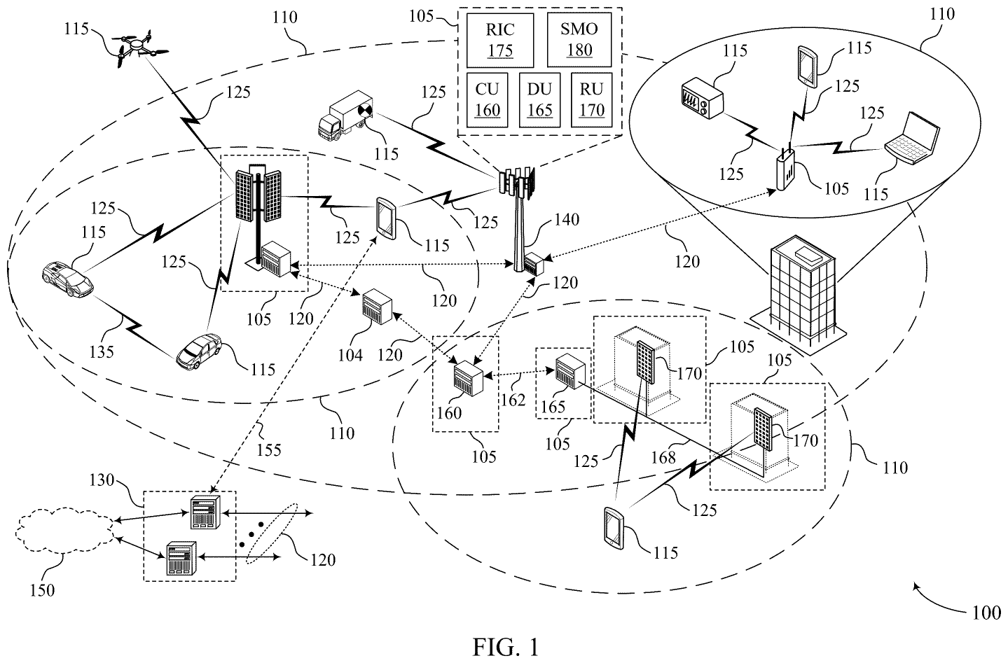

FIG. 1 shows an example of a wireless communications system 100 that supports power control determination for non-uniform bit distributions in accordance with one or more examples as disclosed herein. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, a UE 115 and a network entity 105 may support one or more mechanisms according to which the UE 115 and the network entity 105 may perform power control for transmissions that accounts for non-uniform distributions of bits. For example, the UE may determine a BPRE parameter (e.g., that is used in a calculation for power control of transmissions) that may express, incorporate, or be associated with the effective information that is to be transmitted in message bits of a message set of one or more messages. In some examples, the effective information, the BPRE parameter, or both, may include or be based on an average entropy information (or other information) of the message set (or one or more messages of the message set). Additionally, or alternatively, the effective information, the BPRE parameter, or both, may include or be based on message specific probability information. The BPRE parameter may be used to determine the transmit power for one or more messages of the message set. In some examples, the same transmit power may be used for transmission of a demodulation reference signal (DMRS).

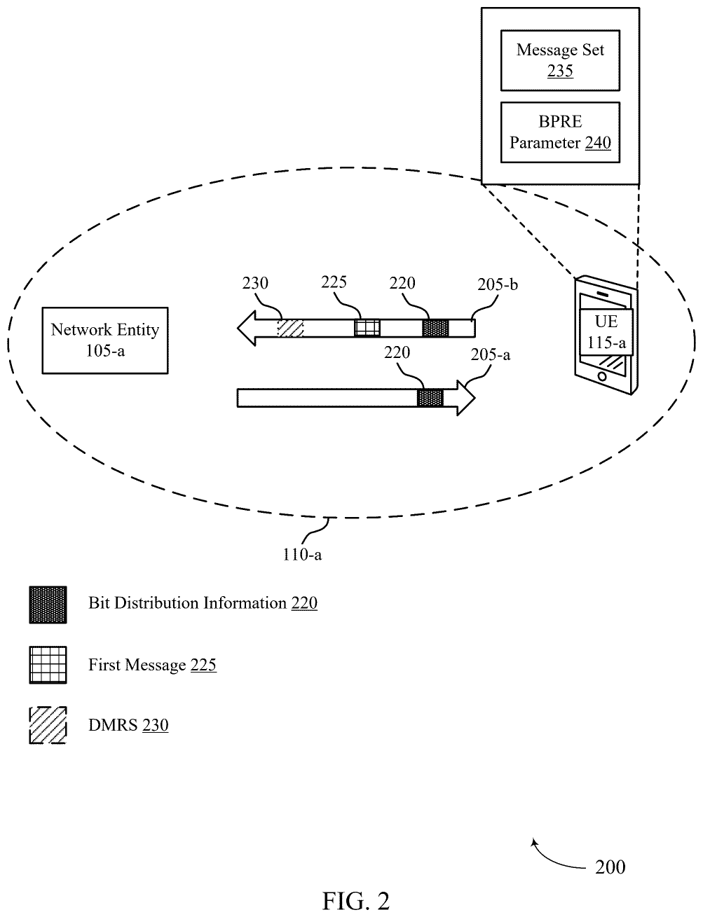

FIG. 2 shows an example of a wireless communications system 200 that supports power control determination for non-uniform bit distributions in accordance with one or more examples as disclosed herein.

The wireless communications system 200 may include the network entity 105-a, which may be an example of one or more network entities discussed in relation to other figures. The wireless communications system 200 may include the UE 115-a, which may be an example of UEs discussed in relation to other figures.

In some examples, the UE 115-a may be located in a geographic coverage area 110-a that may be associated with the network entity 105-a. The network entity 105-a and UE 115-a may communicate via one or more downlink communication links 205-a and one or more uplink communication links 205-b.

In wireless communications, power control operations are performed in cellular communication, including in uplink communications. Such power control operations may be designed or adjusted so that a device (e.g., a UE) uses just enough power to transmit a packet such that a receiving device can decode the transmission. Using less power may result in decoding failure and using more power may drain UE battery or cause too much interference to other UEs in the same or neighboring cells.

In some approaches to power control, it may be assumed that the source information is independent and identically distributed (e.g., uniformly distributed among {0,1}). However, such approaches may be improved, such as to better support scenarios in which the source information to be transmitted contains redundancy (e.g., either has biased distribution across Os, Is, or has strong memory among bits) or is otherwise non-uniform.

Some techniques discussed herein are described in association with uplink control channel transmissions (e.g., physical uplink control channel (PUCCH) transmissions). However, the techniques described herein apply equally to other transmissions, including those in other directions (e.g., downlink or sidelink transmissions) or transmitting different types of information (e.g., shared channel transmissions) or on other channels (physical downlink control channel (PDCCH), physical broadcast channel (PBCH), physical downlink shared channel (PDSCH), physical uplink shared channel (PUSCH), physical sidelink shared channels (PSSCH), or other channels). It is to be understood that the techniques described herein may apply to any type of transmissions, channels, and wireless devices.

In some approaches, a transmission power may be scaled for each code word. For example, the transmission power may be scaled with respect to the Shannon coding length of the corresponding message. For example, a message x^{k} may be encoded and modulated (e.g., via binary phase shift keying (BPSK)) and a codeword c(x^{k}) may be generated. The transmission power may be scaled via power scaling (e.g., represented by

$$log ( \frac{1}{p ( {x}^{k} )} ) ) .$$

In some examples, a normalization factor (e.g., a) may be applied to the power scaled transmission. Such a normalization may have or be associated with a unit expected power across a codebook. In some examples, such an approach may be associated with a Maxwell-Boltzmann distribution for probabilistic shaping (e.g., log p(x)˜|x|²).

In some examples, a transmit power of a UE (e.g., for a PUCCH transmission) may be expressed using Equation 1.

$${P}_{PUCCH} = min \{ {P}_{C , max} , {P}_{0} ( j ) + P L ( q ) + 10 {log}_{10} ( {2}^{μ} {M}_{R B} ) + {Δ}_{F} + {Δ}_{T F} + g ( l ) \} \qquad ( 1 )$$

In equation 1, the parameter P_{C,max} may represent a maximum transmit power. P₀₍ⱼ₎ may represent may be an open loop power control parameter (e.g., an indicated intended receive power at a network entity). PL(q) may indicate a path-loss measured by downlink reference signals. q may be path-loss index (e.g., which may be useful for beam-based power control).

M_{RB} may represent a quantity of resource blocks (RBs) of a transmission (e.g., a PUCCH transmission), which may correspond with or may be associated with a bandwidth of a transmission. Δ_{F} may be an parameter (e.g., an RRC configured parameter) that may be specific to a transmission format (e.g., a PUCCH format). Δ_{TF} may be a delta power parameter that may be based on a spectral efficiency of a transmission (e.g., a PUCCH transmission). In some examples, Δ_{TF}=10 log₁₀((2^{BPRE*K}^{₂}−1)), such as in situations in which a quantity of uplink control information bits satisfies a threshold (e.g., if such a quantity is >11), where, in some examples, K₂=2.4. In some examples, Δ_{TF}=10 log₁₀(BPRE*K₁), such as in situations in which a quantity of uplink control information bits satisfies a threshold (e.g., if such a quantity is <11). In some examples, the BPRE parameter 240 may be expressed as

$$BPRE = \frac{quantity of UCI bits including CRC bits}{{N}_{R E}} ,$$

where the BPRE parameter represents the rate (e.g., a spectral efficiency) of the transmission (e.g., a PUCCH transmission), where N_{RE} denotes the quantity of resource elements (REs) used to transmit information (e.g., UCI). In some examples, g(l) may be a closed-loop power control parameter. In some examples, the main parameters of interest that control the power of a transmission (e.g., a PUCCH transmission) may be P₀, Δ_{TF}, and g(l).

In some examples involving the Δ_{TF} parameter (e.g., involving Δ_{TF}=10 log₁₀(BPRE*K₁)), in situations in which a quantity of uplink control information bits satisfies a threshold (e.g., if such a quantity is <11 bits)), the BPRE may be determined based on BPRE

$$B P R E = \frac{Quantity of actual UCI bits excluding dummy bits}{{N}_{R E}} .$$

In such examples, if a transmission contains some dummy bits (e.g., padding bits added in a HARQ-ACK codebook), the receiving device may be aware of the location and value of the dummy bits and little or no transmit energy may be expended on these bits. In other words, the transmit power is not determined based on the total size (e.g., quantity of bits) of the payload, but rather based on “effective information” or “actual information” included in the payload. In such cases, it would be wasteful to transmit with more power (and, additionally, or alternatively, may also negatively influence power control outer loops). But, such approaches may not be applicable to other non-uniform distributions of bits in messages.

As such, techniques described herein may include techniques for adjusting power control determinations for non-uniform distributions of bits in messages (e.g., that may be applicable to a variety of scenarios). For example, for information sources with non-uniform bit distributions, the BPRE parameter 240 may be modified to incorporate the “effective information” of the message bits. For example, the BPRE parameter 240 may be expressed as

$$B P R E = \frac{effective information}{{N}_{R E}} .$$

In some examples, the effective information may include cyclic redundancy check (CRC) bits.

For example, the UE 115-a may communicate (e.g., transmit or receive) the bit distribution information 220. The bit distribution information 220 may indicate information about how bits are distributed throughout a message set 235 (which may be an uncompressed message set) that may include the first message 225 that is to be transmitted by the UE 115-a. The UE 115-a may transmit the first message 225 using a transmit power that may be based on the BPRE parameter 240 which may be a function of the bit distribution information 220, a quantity of REs associated with the first message 225, or both.

In some examples, message set-dependent power control techniques may be employed. For example, the effective information may be defined by or may include entropy information of the message set 235. For example, an average entropy of the message set 235 may be used to calculate the effective information or quantity of bits, which may be represented by

$$effective information = \frac{entropy of message set + quantity of CRC bits}{{N}_{RE}} .$$

In some examples, the entropy of the message set 235 may be represented by

$${\sum }_{x} k p ( {x}^{K} ) log ( \frac{1}{p ( {x}^{K} )} ) ,$$

where x^{K} runs through at least a portion of the messages of the message set 235. As such, in some examples, a power scaling of a transmission power may be based on such a logarithmic expression. For example, such a power scaling may be inversely proportional to the log of the probability information (e.g., p(x^{K})).

For example, given a 4 bit independently and identically distributed (i.i.d.) HARQ acknowledgment (ACK) or negative acknowledgment (NACK) transmission that includes an ACK probability of 0.9 and a NACK probability of 0.1, the entropy of the message set 235 may be expressed as entropy=4*H(0.1)˜2 bits. In this example, the message set 235 may include the different possible 4 bit combinations, and each message in the message set 235 may include 4 bits. In some examples, it may be desirable for the UE 115-a to ascertain the actual entropy which may be based on the marginal distribution of the bits in the message set 235 or may be based on the joint distribution of the bits in the message set 235. In some examples, the entropy, the marginal distribution, the joint distribution, or any combination thereof, may be indicated to the UE 115-a by the network entity 105-a.

In some examples, the same determined transmit power may be used when transmitting each message in the message set 235 (e.g., not just for the first message 225) regardless of the probability of each message in the message set 235. For example, the UE 115-a may transmit the DMRS 230 using the same transmit power that was determined for the first message 225. In some such examples, a traffic to pilot ratio (TPR) may be 1.

In some examples in which the sources (e.g., messages or a message set) include or are associated with a non-uniform distribution, it is generally much easier for the decoder to decode the message. As such, the UE 115-a may reduce the transmit power used. In comparison, other approaches for power control (e.g., those based only on a quantity of bits) waste power at the UE 115-a (e.g., draining the battery of the UE 115-a), this could also negatively affect the closed-loop power control at the network entity 105-a.

In some examples, the network entity 105-a may employ the decoding results of a transmission (e.g., the first message 225, which may be a PUCCH transmission) to determine a closed-loop power control command (e.g., g(l) described herein). If the decoding is correct (e.g., due to a lower entropy of the source), the outer-loop parameter at the network entity 105-a may not be able to track channel conditions accurately.

In some examples, message-dependent power control techniques may be employed. For example, for non-uniform bit distributions, a varying power across a codebook may be included in the BPRE parameter 240 as expressed by

$$BPRE ( {x}^{k} ) = \frac{log ( \frac{1}{p ( {x}^{K} )} )}{{N}_{R E}} + \frac{quantity of CRC bits}{{N}_{R E}} .$$

In such an expression, x^{k} may refer to an uncompressed message, such as the first message 225 (e.g., excluding CRC bits). In some examples, the effective information may be expressed as

$$log ( \frac{1}{p ( {x}^{K} )} )$$

and such effective information may depend on an individual message (e.g., the first message 225). The BPRE parameter 240 may be message-specific.

For a general case, an arbitrary scalar (e.g., such as α(x^{k})) may be employed as a power scaler for message x^{k}. For example, the BPRE parameter 240 may be expressed as

$$BPRE ( {X}^{K} ) = \frac{entropy of messageset}{{N}_{R E}} * α ( {x}^{K} ) + \frac{quantity of CRC bits}{{N}_{R E}} .$$

Additionally, or alternatively, the BPRE parameter 240 may be expressed as

$$BPRE ( {X}^{K} ) = \frac{entropy of message set + quantity of CRC bits}{{N}_{RE}} * α ( {x}^{K} , quantity of CRC bits ) .$$

In some examples, the network entity 105-a may configure the p(x^{k}) terms for each of the messages in the message set 235. Additionally, or alternatively, the network entity 105-a may configure a parameter for the UE 115-a to compute the probability term (e.g., a marginal probability of bits and correlation).

In some examples (e.g., those involving message-dependent power control techniques), the transmission power for transmitting a message or data part may depend on which message or data part is to be transmitted. In such cases, a DMRS transmission power (e.g., for the DMRS 230) may be determined based on an average entropy of the message set 235. In some examples, a parameter such as BPRE_data, BPRE_DMRS, or both, may be employed to express the determination based on the average entropy of the message set (e.g., in cases in which the transmit power is message dependent). In some examples, BPRE_data may be calculated in accordance with message-dependent power control techniques (e.g., as described herein) and BPRE_DMRS may be calculated in accordance with message set-dependent power control techniques (e.g., as described herein).

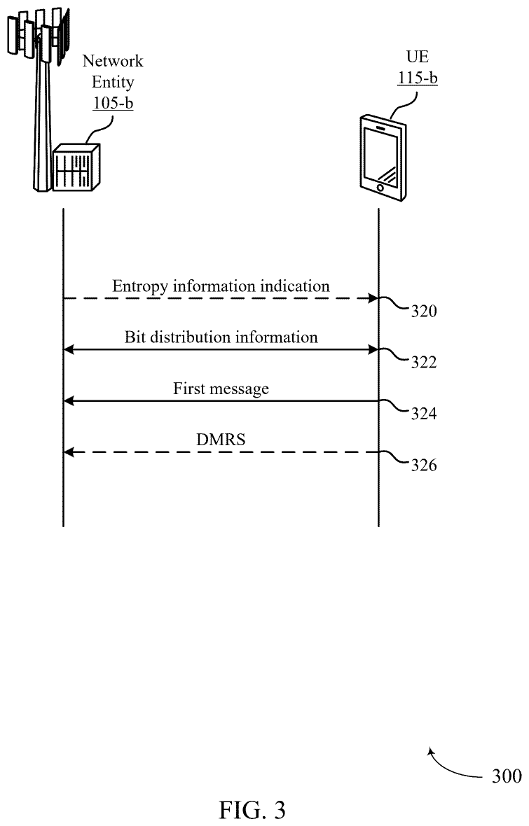

FIG. 3 shows an example of a process flow 300 that supports power control determination for non-uniform bit distributions in accordance with one or more examples as disclosed herein. The process flow 300 may implement various aspects of the present disclosure described herein. The elements described in the process flow 300 (e.g., UE 115-b and network entity 105-b) may be examples of similarly named elements described herein.

In the following description of the process flow 300, the operations between the various entities or elements may be performed in different orders or at different times. Some operations may also be left out of the process flow 300, or other operations may be added. Although the various entities or elements are shown performing the operations of the process flow 300, some aspects of some operations may also be performed by other entities or elements of the process flow 300 or by entities or elements that are not depicted in the process flow, or any combination thereof.

At 320, the UE 115-b may receive an indication designating the entropy information as marginal distribution information or joint distribution information.

At 322, the UE 115-b may communicate bit distribution information for an uncompressed message set, the uncompressed message set that may include a plurality of messages and the bit distribution information that may indicate a distribution of bits included in one or more messages of the plurality of messages of the uncompressed message set.

In some examples, the bit distribution information may include entropy information associated with the uncompressed message set. In some examples, the entropy information may include an average entropy for the plurality of messages of the uncompressed message set. In some examples, the entropy information is based on a marginal distribution of bits of one or more messages from the uncompressed message set or a joint distribution of bits of one or more messages from the uncompressed message set. In some examples, the bit distribution information may include probability information associated with a quantity of bits of the first message. In some examples, a power scaling of the transmit power is inversely proportional to a logarithmic function of the probability information.

In some examples, reception of the bit distribution information may include receiving the probability information, or receiving a parameter for calculating the probability information, the parameter that may include an indication of a marginal probability of occurrence of bits associated with the first message and correlation information.

At 324, the UE 115-b may transmit, at a transmit power determined in accordance with a bits per resource element (BPRE) parameter, a first message from the plurality of messages of the uncompressed message set and the BPRE parameter is a function of the bit distribution information for the uncompressed message set and a quantity of resource elements utilized for transmission of the first message. In some examples, the transmit power is specific to the first message.

In some examples, the BPRE parameter is associated with a transmit power adjustment parameter of a transmit power calculation that determines the transmit power for transmission of the first message. In some examples, the BPRE parameter is based on a power scaling parameter associated with the first message. In some examples, the BPRE parameter is based on a quantity of cyclic redundancy check bits associated with the first message.

At 326, the UE 115-b may transmit a demodulation reference signal associated with the first message and the first message and the demodulation reference signal are each transmitted at the transmit power. In some examples, a second transmit power of a reference signal (e.g., the demodulation reference signal) is based on an average entropy of the uncompressed message set.

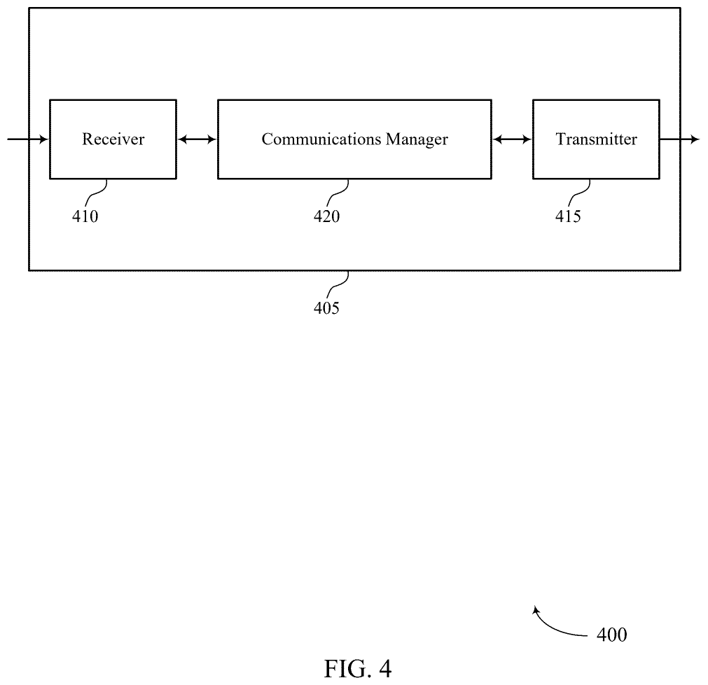

FIG. 4 shows a block diagram 400 of a device 405 that supports power control determination for non-uniform bit distributions in accordance with one or more examples as disclosed herein. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to power control determination for non-uniform bit distributions). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to power control determination for non-uniform bit distributions). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of power control determination for non-uniform bit distributions as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

Additionally, or alternatively, the communications manager 420 may support wireless communications in accordance with examples as disclosed herein. For example, the communications manager 420 is capable of, configured to, or operable to support a means for communicating bit distribution information for an uncompressed message set, the uncompressed message set including a set of multiple messages and the bit distribution information indicating a distribution of bits included in one or more messages of the set of multiple messages of the uncompressed message set. The communications manager 420 is capable of, configured to, or operable to support a means for transmitting, at a transmit power determined in accordance with a bits per resource element (BPRE) parameter, a first message from the set of multiple messages of the uncompressed message set, where the BPRE parameter is a function of the bit distribution information for the uncompressed message set and a quantity of resource elements utilized for transmission of the first message.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, more efficient utilization of communication resources, or any combination thereof.

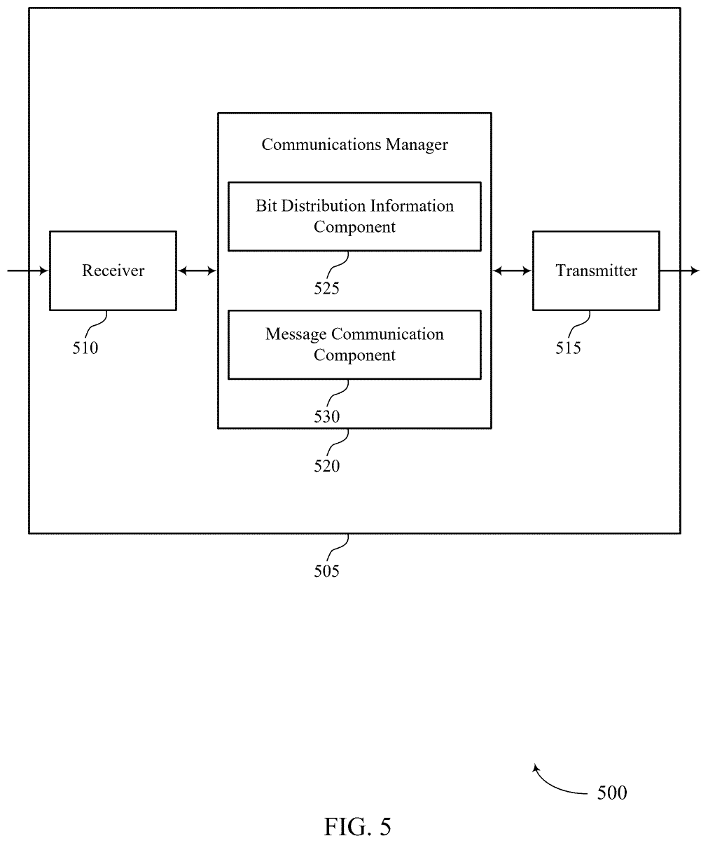

FIG. 5 shows a block diagram 500 of a device 505 that supports power control determination for non-uniform bit distributions in accordance with one or more examples as disclosed herein. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to power control determination for non-uniform bit distributions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to power control determination for non-uniform bit distributions). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of power control determination for non-uniform bit distributions as described herein. For example, the communications manager 520 may include a bit distribution information component 525 a message communication component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The bit distribution information component 525 is capable of, configured to, or operable to support a means for communicating bit distribution information for an uncompressed message set, the uncompressed message set including a set of multiple messages and the bit distribution information indicating a distribution of bits included in one or more messages of the set of multiple messages of the uncompressed message set. The message communication component 530 is capable of, configured to, or operable to support a means for transmitting, at a transmit power determined in accordance with a bits per resource element (BPRE) parameter, a first message from the set of multiple messages of the uncompressed message set, where the BPRE parameter is a function of the bit distribution information for the uncompressed message set and a quantity of resource elements utilized for transmission of the first message.

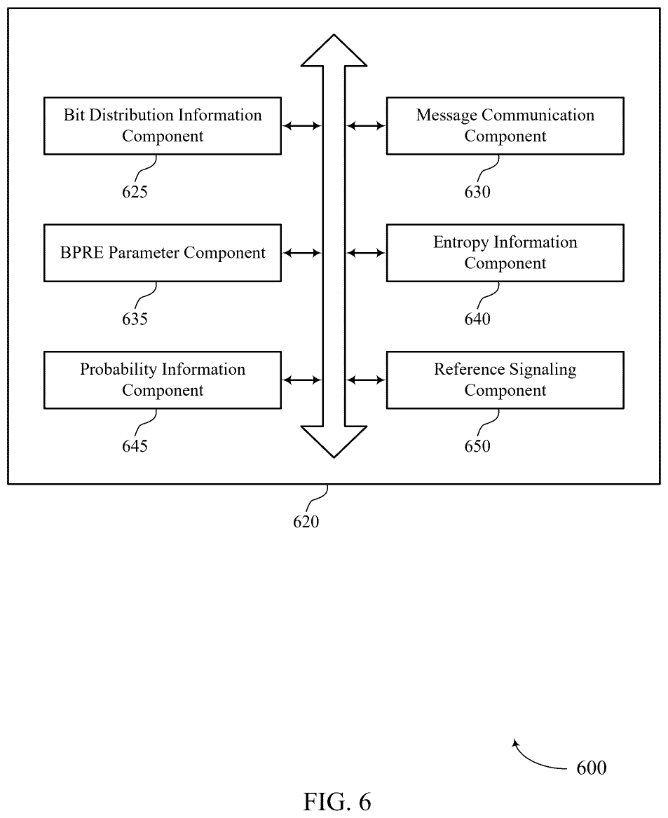

FIG. 6 shows a block diagram 600 of a communications manager 620 that supports power control determination for non-uniform bit distributions in accordance with one or more examples as disclosed herein. The communications manager 620 may be an example of aspects of a communications manager 420, a communications manager 520, or both, as described herein. The communications manager 620, or various components thereof, may be an example of means for performing various aspects of power control determination for non-uniform bit distributions as described herein. For example, the communications manager 620 may include a bit distribution information component 625, a message communication component 630, a BPRE parameter component 635, an entropy information component 640, a probability information component 645, a reference signaling component 650, or any combination thereof. Each of these components, or components or subcomponents thereof (e.g., one or more processors, one or more memories), may communicate, directly or indirectly, with one another (e.g., via one or more buses).

Additionally, or alternatively, the communications manager 620 may support wireless communications in accordance with examples as disclosed herein. The bit distribution information component 625 is capable of, configured to, or operable to support a means for communicating bit distribution information for an uncompressed message set, the uncompressed message set including a set of multiple messages and the bit distribution information indicating a distribution of bits included in one or more messages of the set of multiple messages of the uncompressed message set. The message communication component 630 is capable of, configured to, or operable to support a means for transmitting, at a transmit power determined in accordance with a bits per resource element (BPRE) parameter, a first message from the set of multiple messages of the uncompressed message set, where the BPRE parameter is a function of the bit distribution information for the uncompressed message set and a quantity of resource elements utilized for transmission of the first message.

In some examples, the BPRE parameter is associated with a transmit power adjustment parameter of a transmit power calculation that determines the transmit power for transmission of the first message.

In some examples, the bit distribution information includes entropy information associated with the uncompressed message set.

In some examples, the entropy information includes an average entropy for the set of multiple messages of the uncompressed message set.

In some examples, the entropy information is based on a marginal distribution of bits of one or more messages from the uncompressed message set or a joint distribution of bits of one or more messages from the uncompressed message set.

In some examples, the entropy information component 640 is capable of, configured to, or operable to support a means for receiving an indication designating the entropy information as marginal distribution information or joint distribution information.

In some examples, the reference signaling component 650 is capable of, configured to, or operable to support a means for transmitting a demodulation reference signal associated with the first message, where the first message and the demodulation reference signal are each transmitted at the transmit power.

In some examples, the bit distribution information includes probability information associated with a quantity of bits of the first message.

In some examples, a power scaling of the transmit power is inversely proportional to a logarithmic function of the probability information.

In some examples, the BPRE parameter is based on a power scaling parameter associated with the first message.

In some examples, to support communicating the bit distribution information, the probability information component 645 is capable of, configured to, or operable to support a means for receiving the probability information. In some examples, to support communicating the bit distribution information, the probability information component 645 is capable of, configured to, or operable to support a means for receiving a parameter for calculating the probability information, the parameter including an indication of a marginal probability of occurrence of bits associated with the first message and correlation information.

In some examples, the transmit power is specific to the first message. In some examples, a second transmit power of a reference signal is based on an average entropy of the uncompressed message set.

In some examples, the BPRE parameter is based on a quantity of cyclic redundancy check bits associated with the first message.

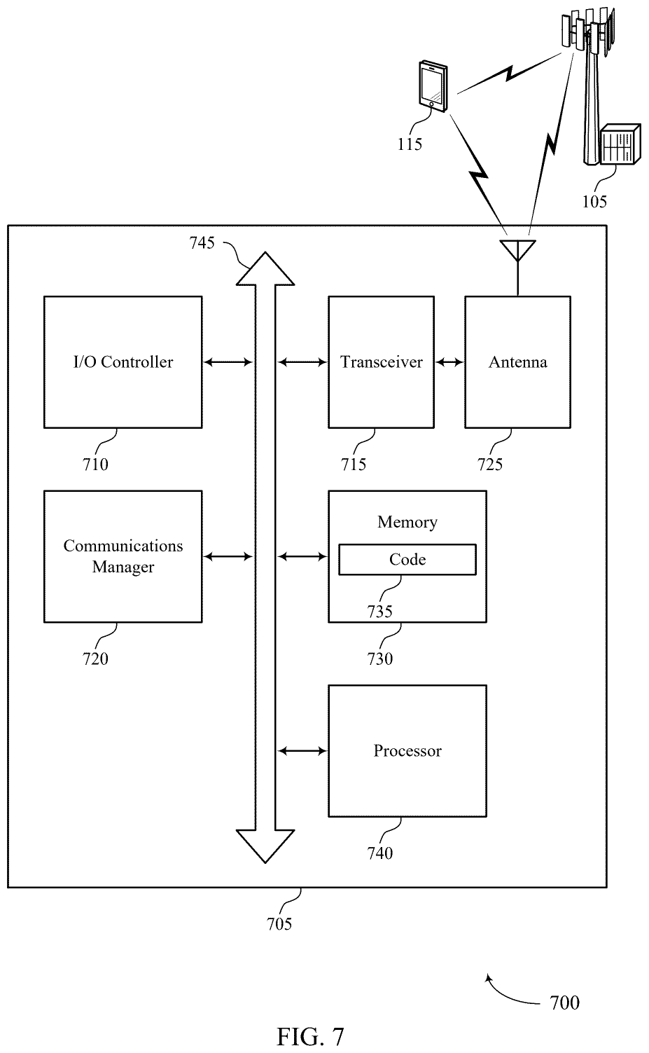

FIG. 7 shows a diagram of a system 700 including a device 705 that supports power control determination for non-uniform bit distributions in accordance with one or more examples as disclosed herein. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting power control determination for non-uniform bit distributions). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

Additionally, or alternatively, the communications manager 720 may support wireless communications in accordance with examples as disclosed herein. For example, the communications manager 720 is capable of, configured to, or operable to support a means for communicating bit distribution information for an uncompressed message set, the uncompressed message set including a set of multiple messages and the bit distribution information indicating a distribution of bits included in one or more messages of the set of multiple messages of the uncompressed message set. The communications manager 720 is capable of, configured to, or operable to support a means for transmitting, at a transmit power determined in accordance with a bits per resource element (BPRE) parameter, a first message from the set of multiple messages of the uncompressed message set, where the BPRE parameter is a function of the bit distribution information for the uncompressed message set and a quantity of resource elements utilized for transmission of the first message.

By including or configuring the communications manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of power control determination for non-uniform bit distributions as described herein, or the at least one processor 740 and the at least one memory 730 may be otherwise configured to, individually or collectively, perform or support such operations.

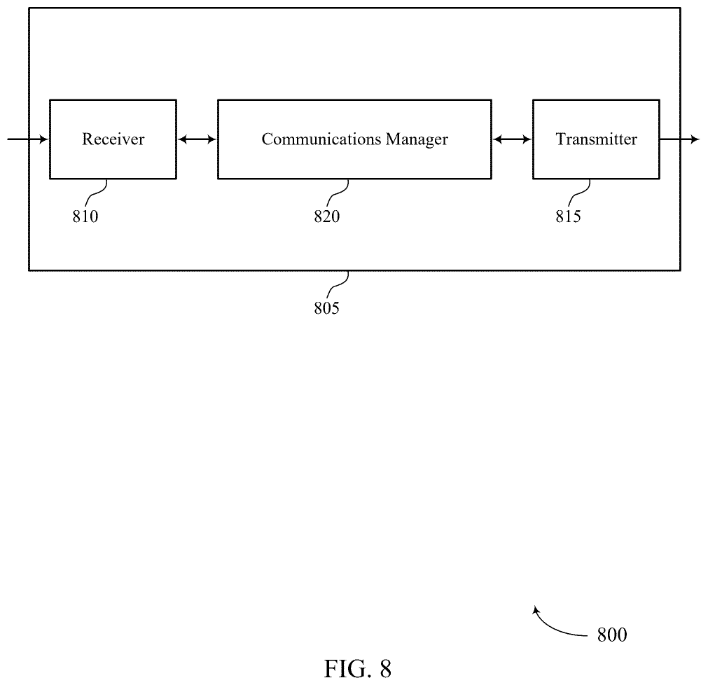

FIG. 8 shows a block diagram 800 of a device 805 that supports power control determination for non-uniform bit distributions in accordance with one or more examples as disclosed herein. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of power control determination for non-uniform bit distributions as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

Additionally, or alternatively, the communications manager 820 may support wireless communications in accordance with examples as disclosed herein. For example, the communications manager 820 is capable of, configured to, or operable to support a means for communicating bit distribution information for an uncompressed message set, the uncompressed message set including a set of multiple messages and the bit distribution information indicating a distribution of bits included in one or more messages of the set of multiple messages of the uncompressed message set. The communications manager 820 is capable of, configured to, or operable to support a means for receiving a first message from the plurality of messages of the uncompressed message set, the first message communicated at a transmit power determined in accordance with a bits per resource element (BPRE) parameter, where the BPRE parameter is a function of the bit distribution information for the uncompressed message set and a quantity of resource elements utilized for transmission of the first message.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, more efficient utilization of communication resources, or any combination thereof.

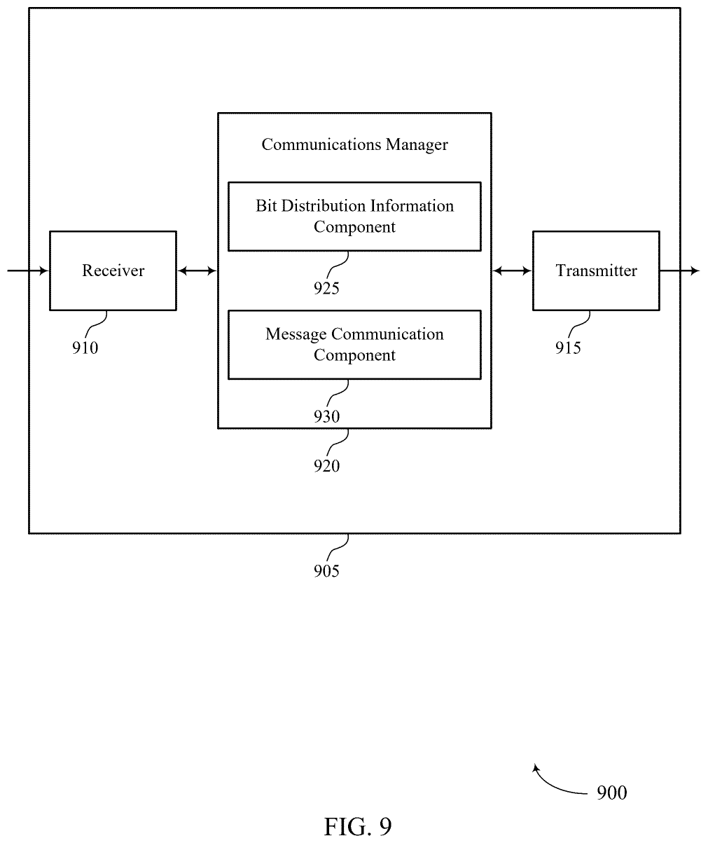

FIG. 9 shows a block diagram 900 of a device 905 that supports power control determination for non-uniform bit distributions in accordance with one or more examples as disclosed herein. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of power control determination for non-uniform bit distributions as described herein. For example, the communications manager 920 may include a bit distribution information component 925 a message communication component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The bit distribution information component 925 is capable of, configured to, or operable to support a means for communicating bit distribution information for an uncompressed message set, the uncompressed message set including a set of multiple messages and the bit distribution information indicating a distribution of bits included in one or more messages of the set of multiple messages of the uncompressed message set. The message communication component 930 is capable of, configured to, or operable to support a means for receiving (e.g., obtaining) a first message from the plurality of messages of the uncompressed message set, the first message communicated at a transmit power determined in accordance with a bits per resource element (BPRE) parameter, where the BPRE parameter is a function of the bit distribution information for the uncompressed message set and a quantity of resource elements utilized for transmission of the first message.

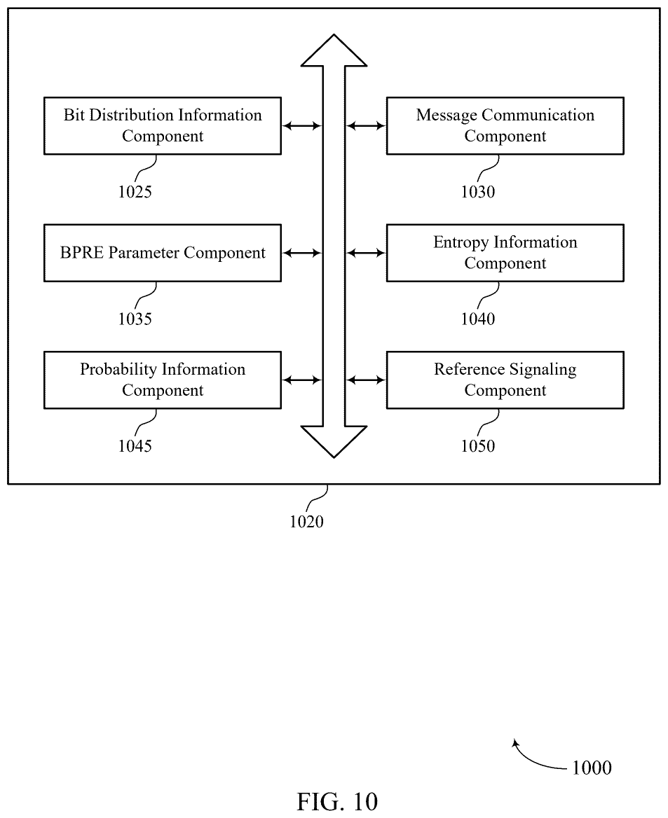

FIG. 10 shows a block diagram 1000 of a communications manager 1020 that supports power control determination for non-uniform bit distributions in accordance with one or more examples as disclosed herein. The communications manager 1020 may be an example of aspects of a communications manager 820, a communications manager 920, or both, as described herein. The communications manager 1020, or various components thereof, may be an example of means for performing various aspects of power control determination for non-uniform bit distributions as described herein. For example, the communications manager 1020 may include a bit distribution information component 1025, a message communication component 1030, a BPRE parameter component 1035, an entropy information component 1040, a probability information component 1045, a reference signaling component 1050, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1020 may support wireless communications in accordance with examples as disclosed herein. The bit distribution information component 1025 is capable of, configured to, or operable to support a means for communicating bit distribution information for an uncompressed message set, the uncompressed message set including a set of multiple messages and the bit distribution information indicating a distribution of bits included in one or more messages of the set of multiple messages of the uncompressed message set. The message communication component 1030 is capable of, configured to, or operable to support a means for receiving (e.g., obtaining) a first message from the plurality of messages of the uncompressed message set, the first message communicated at a transmit power determined in accordance with a bits per resource element (BPRE) parameter, where the BPRE parameter is a function of the bit distribution information for the uncompressed message set and a quantity of resource elements utilized for transmission of the first message.

In some examples, the BPRE parameter is associated with a transmit power adjustment parameter of a transmit power calculation that determines the transmit power for transmission of the first message.

In some examples, the bit distribution information includes entropy information associated with the uncompressed message set.

In some examples, the entropy information includes an average entropy for the set of multiple messages of the uncompressed message set.

In some examples, the entropy information is based on a marginal distribution of bits of one or more messages from the uncompressed message set or a joint distribution of bits of one or more messages from the uncompressed message set.

In some examples, the entropy information component 1040 is capable of, configured to, or operable to support a means for transmitting an indication designating the entropy information as marginal distribution information or joint distribution information.

In some examples, the reference signaling component 1050 is capable of, configured to, or operable to support a means for receiving a demodulation reference signal associated with the first message, where the first message and the demodulation reference signal are each transmitted at the transmit power.

In some examples, the bit distribution information includes probability information associated with a quantity of bits of the first message.

In some examples, a power scaling of the transmit power is inversely proportional to a logarithmic function of the probability information.

In some examples, the BPRE parameter is based on a power scaling parameter associated with the first message.

In some examples, to support communicating the bit distribution information, the probability information component 1045 is capable of, configured to, or operable to support a means for transmitting the probability information. In some examples, to support communicating the bit distribution information, the probability information component 1045 is capable of, configured to, or operable to support a means for transmitting a parameter for calculating the probability information, the parameter including an indication of a marginal probability of occurrence of bits associated with the first message and correlation information.

In some examples, the transmit power is specific to the first message. In some examples, a second transmit power of a reference signal is based on an average entropy of the uncompressed message set.

In some examples, the BPRE parameter is based on a quantity of cyclic redundancy check bits associated with the first message.

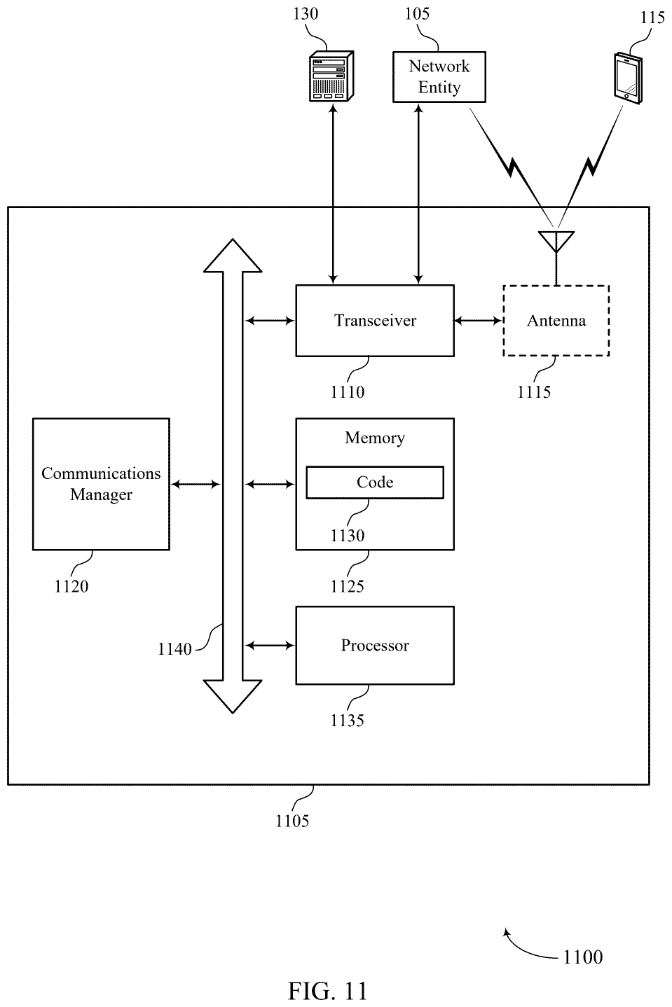

FIG. 11 shows a diagram of a system 1100 including a device 1105 that supports power control determination for non-uniform bit distributions in accordance with one or more examples as disclosed herein. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting power control determination for non-uniform bit distributions). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

Additionally, or alternatively, the communications manager 1120 may support wireless communications in accordance with examples as disclosed herein. For example, the communications manager 1120 is capable of, configured to, or operable to support a means for communicating bit distribution information for an uncompressed message set, the uncompressed message set including a set of multiple messages and the bit distribution information indicating a distribution of bits included in one or more messages of the set of multiple messages of the uncompressed message set. The communications manager 1120 is capable of, configured to, or operable to support a means for receiving (e.g., obtaining) a first message from the plurality of messages of the uncompressed message set, the first message communicated at a transmit power determined in accordance with a bits per resource element (BPRE) parameter, where the BPRE parameter is a function of the bit distribution information for the uncompressed message set and a quantity of resource elements utilized for transmission of the first message.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of power control determination for non-uniform bit distributions as described herein, or the at least one processor 1135 and the at least one memory 1125 may be otherwise configured to, individually or collectively, perform or support such operations.

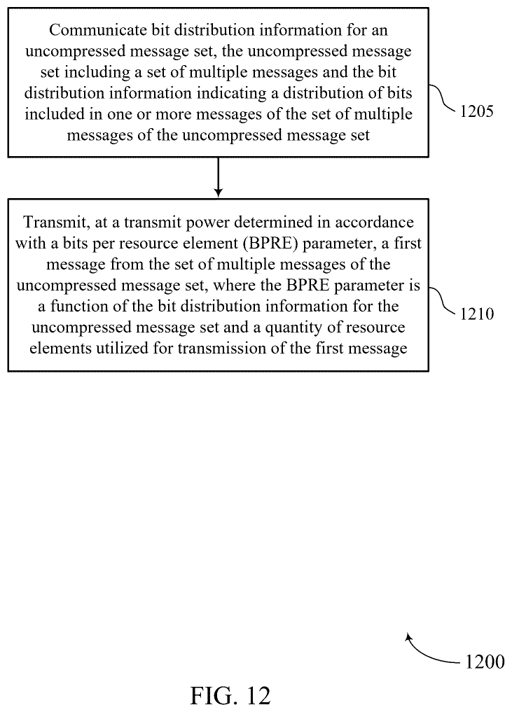

FIG. 12 shows a flowchart illustrating a method 1200 that supports power control determination for non-uniform bit distributions in accordance with one or more examples as disclosed herein. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include communicating bit distribution information for an uncompressed message set, the uncompressed message set including a set of multiple messages and the bit distribution information indicating a distribution of bits included in one or more messages of the set of multiple messages of the uncompressed message set. The operations of 1205 may be performed in accordance with examples as disclosed herein. In some examples, aspects of the operations of 1205 may be performed by a bit distribution information component 625 as described with reference to FIG. 6.

At 1210, the method may include transmitting, at a transmit power determined in accordance with a bits per resource element (BPRE) parameter, a first message from the set of multiple messages of the uncompressed message set, where the BPRE parameter is a function of the bit distribution information for the uncompressed message set and a quantity of resource elements utilized for transmission of the first message. The operations of 1210 may be performed in accordance with examples as disclosed herein. In some examples, aspects of the operations of 1210 may be performed by a message communication component 630 as described with reference to FIG. 6.

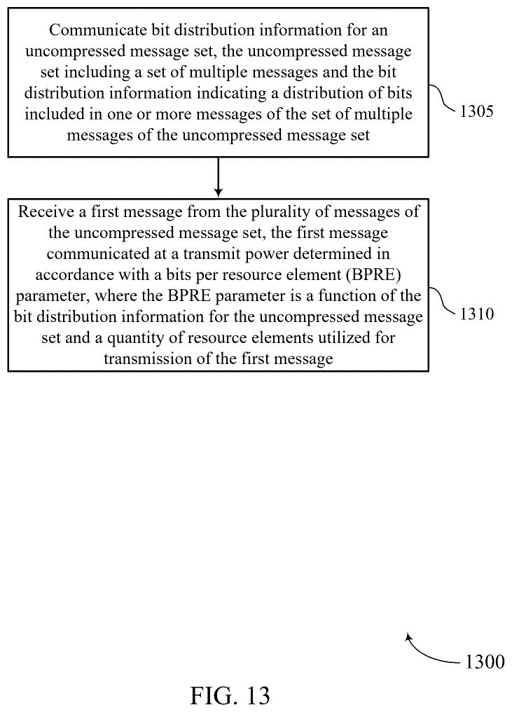

FIG. 13 shows a flowchart illustrating a method 1300 that supports power control determination for non-uniform bit distributions in accordance with one or more examples as disclosed herein. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include communicating bit distribution information for an uncompressed message set, the uncompressed message set including a set of multiple messages and the bit distribution information indicating a distribution of bits included in one or more messages of the set of multiple messages of the uncompressed message set. The operations of 1305 may be performed in accordance with examples as disclosed herein. In some examples, aspects of the operations of 1305 may be performed by a bit distribution information component 1025 as described with reference to FIG. 10.

At 1310, the method may include receiving (e.g., obtaining) a first message from the plurality of messages of the uncompressed message set, the first message communicated at a transmit power determined in accordance with a bits per resource element (BPRE) parameter, where the BPRE parameter is a function of the bit distribution information for the uncompressed message set and a quantity of resource elements utilized for transmission of the first message. The operations of 1310 may be performed in accordance with examples as disclosed herein. In some examples, aspects of the operations of 1310 may be performed by a message communication component 1030 as described with reference to FIG. 10.

The following provides an overview of aspects of the present disclosure:

Aspect 1: A method for wireless communications at a wireless device, comprising: communicating bit distribution information for an uncompressed message set, the uncompressed message set comprising a plurality of messages and the bit distribution information indicating a distribution of bits included in one or more messages of the plurality of messages of the uncompressed message set; and transmitting, at a transmit power determined in accordance with a bits per resource element (BPRE) parameter, a first message from the plurality of messages of the uncompressed message set, wherein the BPRE parameter is a function of the bit distribution information for the uncompressed message set and a quantity of resource elements utilized for transmission of the first message.

Aspect 2: The method of aspect 1, wherein the BPRE parameter is associated with a transmit power adjustment parameter of a transmit power calculation that determines the transmit power for transmission of the first message.

Aspect 3: The method of any of aspects 1 through 2, wherein the bit distribution information comprises entropy information associated with the uncompressed message set.

Aspect 4: The method of aspect 3, wherein the entropy information comprises an average entropy for the plurality of messages of the uncompressed message set.

Aspect 5: The method of any of aspects 3 through 4, wherein the entropy information is based at least in part on a marginal distribution of bits of one or more messages from the uncompressed message set or a joint distribution of bits of one or more messages from the uncompressed message set.

Aspect 6: The method of any of aspects 3 through 5, further comprising: receiving an indication designating the entropy information as marginal distribution information or joint distribution information.

Aspect 7: The method of any of aspects 3 through 6, further comprising: transmitting a demodulation reference signal associated with the first message, wherein the first message and the demodulation reference signal are each transmitted at the transmit power.

Aspect 8: The method of any of aspects 1 through 7, wherein the bit distribution information comprises probability information associated with a quantity of bits of the first message.

Aspect 9: The method of aspect 8, wherein a power scaling of the transmit power is inversely proportional to a logarithmic function of the probability information.

Aspect 10: The method of any of aspects 8 through 9, wherein the BPRE parameter is based at least in part on a power scaling parameter associated with the first message.

Aspect 11: The method of any of aspects 8 through 10, wherein communicating the bit distribution information comprises: receiving the probability information; or receiving a parameter for calculating the probability information, the parameter comprising an indication of a marginal probability of occurrence of bits associated with the first message and correlation information.

Aspect 12: The method of any of aspects 8 through 11, wherein the transmit power is specific to the first message; and a second transmit power of a reference signal is based at least in part on an average entropy of the uncompressed message set.

Aspect 13: The method of any of aspects 1 through 12, wherein the BPRE parameter is based at least in part on a quantity of cyclic redundancy check bits associated with the first message.

Aspect 14: A method for wireless communications at a wireless device, comprising: communicating bit distribution information for an uncompressed message set, the uncompressed message set comprising a plurality of messages and the bit distribution information indicating a distribution of bits included in one or more messages of the plurality of messages of the uncompressed message set; and receiving a first message from the plurality of messages of the uncompressed message set, the first message communicated at a transmit power determined in accordance with a bits per resource element (BPRE) parameter, wherein the BPRE parameter is a function of the bit distribution information for the uncompressed message set and a quantity of resource elements utilized for transmission of the first message.

Aspect 15: The method of aspect 14, wherein the BPRE parameter is associated with a transmit power adjustment parameter of a transmit power calculation that determines the transmit power for transmission of the first message.

Aspect 16: The method of any of aspects 14 through 15, wherein the bit distribution information comprises entropy information associated with the uncompressed message set.

Aspect 17: The method of aspect 16, wherein the entropy information comprises an average entropy for the plurality of messages of the uncompressed message set.

Aspect 18: The method of any of aspects 16 through 17, wherein the entropy information is based at least in part on a marginal distribution of bits of one or more messages from the uncompressed message set or a joint distribution of bits of one or more messages from the uncompressed message set.

Aspect 19: The method of any of aspects 16 through 18, further comprising: transmitting an indication designating the entropy information as marginal distribution information or joint distribution information.

Aspect 20: The method of any of aspects 16 through 19, further comprising: receiving a demodulation reference signal associated with the first message, wherein the first message and the demodulation reference signal are each transmitted at the transmit power.

Aspect 21: The method of any of aspects 14 through 20, wherein the bit distribution information comprises probability information associated with a quantity of bits of the first message.

Aspect 22: The method of aspect 21, wherein a power scaling of the transmit power is inversely proportional to a logarithmic function of the probability information.

Aspect 23: The method of any of aspects 21 through 22, wherein the BPRE parameter is based at least in part on a power scaling parameter associated with the first message.

Aspect 24: The method of any of aspects 21 through 23, wherein communicating the bit distribution information comprises: transmitting the probability information; or transmitting a parameter for calculating the probability information, the parameter comprising an indication of a marginal probability of occurrence of bits associated with the first message and correlation information.

Aspect 25: The method of any of aspects 21 through 24, wherein the transmit power is specific to the first message; and a second transmit power of a reference signal is based at least in part on an average entropy of the uncompressed message set.

Aspect 26: The method of any of aspects 14 through 25, wherein the BPRE parameter is based at least in part on a quantity of cyclic redundancy check bits associated with the first message.

Aspect 27: A wireless device for wireless communications, comprising one or more memories storing processor-executable code, and one or more processors coupled with the one or more memories and individually or collectively operable to execute the code to cause the wireless device to perform a method of any of aspects 1 through 13.

Aspect 28: A wireless device for wireless communications, comprising at least one means for performing a method of any of aspects 1 through 13.

Aspect 29: A non-transitory computer-readable medium storing code for wireless communications, the code comprising instructions executable by one or more processors to perform a method of any of aspects 1 through 13.

Aspect 30: A wireless device for wireless communications, comprising one or more memories storing processor-executable code, and one or more processors coupled with the one or more memories and individually or collectively operable to execute the code to cause the wireless device to perform a method of any of aspects 14 through 26.

Aspect 31: A wireless device for wireless communications, comprising at least one means for performing a method of any of aspects 14 through 26.

Aspect 32: A non-transitory computer-readable medium storing code for wireless communications, the code comprising instructions executable by one or more processors to perform a method of any of aspects 14 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
communicate bit distribution information for an uncompressed message set, the uncompressed message set comprising a plurality of messages and the bit distribution information indicating a distribution of bits included in one or more messages of the plurality of messages of the uncompressed message set; and
transmit, at a transmit power determined in accordance with a bits per resource element (BPRE) parameter, a first message from the plurality of messages of the uncompressed message set, wherein the BPRE parameter is a function of the bit distribution information for the uncompressed message set and a quantity of resource elements utilized for transmission of the first message.

2. The wireless device of claim 1, wherein the BPRE parameter is associated with a transmit power adjustment parameter of a transmit power calculation that determines the transmit power for transmission of the first message.

3. The wireless device of claim 1, wherein the bit distribution information comprises entropy information associated with the uncompressed message set.

4. The wireless device of claim 3, wherein the entropy information comprises an average entropy for the plurality of messages of the uncompressed message set.

5. The wireless device of claim 3, wherein the entropy information is based at least in part on a marginal distribution of bits of one or more messages from the uncompressed message set or a joint distribution of bits of one or more messages from the uncompressed message set.

6. The wireless device of claim 3, wherein the one or more processors are individually or collectively further operable to execute the code to cause the wireless device to:
receive an indication designating the entropy information as marginal distribution information or joint distribution information.

7. The wireless device of claim 3, wherein the one or more processors are individually or collectively further operable to execute the code to cause the wireless device to:
transmit a demodulation reference signal associated with the first message, wherein the first message and the demodulation reference signal are each transmitted at the transmit power.

8. The wireless device of claim 1, wherein the bit distribution information comprises probability information associated with a quantity of bits of the first message.

9. The wireless device of claim 8, wherein a power scaling of the transmit power is inversely proportional to a logarithmic function of the probability information.

10. The wireless device of claim 8, wherein the BPRE parameter is based at least in part on a power scaling parameter associated with the first message.

11. The wireless device of claim 8, wherein, to communicate the bit distribution information, the one or more processors are individually or collectively operable to execute the code to cause the wireless device to:
receive the probability information; or
receive a parameter for calculating the probability information, the parameter comprising an indication of a marginal probability of occurrence of bits associated with the first message and correlation information.

12. The wireless device of claim 8, wherein:
the transmit power is specific to the first message; and
a second transmit power of a reference signal is based at least in part on an average entropy of the uncompressed message set.

13. The wireless device of claim 1, wherein the BPRE parameter is based at least in part on a quantity of cyclic redundancy check bits associated with the first message.

14. A wireless device, comprising:
one or more memories storing processor-executable code; and
one or more processors coupled with the one or more memories and individually or collectively operable to execute the code to cause the wireless device to:
communicate bit distribution information for an uncompressed message set, the uncompressed message set comprising a plurality of messages and the bit distribution information indicating a distribution of bits included in one or more messages of the plurality of messages of the uncompressed message set; and
obtain a first message from the plurality of messages of the uncompressed message set, the first message communicated at a transmit power determined in accordance with a bits per resource element (BPRE) parameter, wherein the BPRE parameter is a function of the bit distribution information for the uncompressed message set and a quantity of resource elements utilized for transmission of the first message.

15. The wireless device of claim 14, wherein the BPRE parameter is associated with a transmit power adjustment parameter of a transmit power calculation that determines the transmit power for transmission of the first message.

16. The wireless device of claim 14, wherein the bit distribution information comprises entropy information associated with the uncompressed message set.

17. The wireless device of claim 16, wherein the entropy information comprises an average entropy for the plurality of messages of the uncompressed message set.

18. The wireless device of claim 16, wherein the entropy information is based at least in part on a marginal distribution of bits of one or more messages from the uncompressed message set or a joint distribution of bits of one or more messages from the uncompressed message set.

19. The wireless device of claim 16, wherein the one or more processors are individually or collectively further operable to execute the code to cause the wireless device to:
transmit an indication designating the entropy information as marginal distribution information or joint distribution information.

20. The wireless device of claim 16, wherein the one or more processors are individually or collectively further operable to execute the code to cause the wireless device to:
receive a demodulation reference signal associated with the first message, wherein the first message and the demodulation reference signal are each transmitted at the transmit power.

21. The wireless device of claim 14, wherein the bit distribution information comprises probability information associated with a quantity of bits of the first message.

22. The wireless device of claim 21, wherein a power scaling of the transmit power is inversely proportional to a logarithmic function of the probability information.

23. The wireless device of claim 21, wherein the BPRE parameter is based at least in part on a power scaling parameter associated with the first message.

24. The wireless device of claim 21, wherein, to communicate the bit distribution information, the one or more processors are individually or collectively operable to execute the code to cause the wireless device to:
output the probability information; or
output a parameter for calculating the probability information, the parameter comprising an indication of a marginal probability of occurrence of bits associated with the first message and correlation information.

25. The wireless device of claim 21, wherein:
the transmit power is specific to the first message; and
a second transmit power of a reference signal is based at least in part on an average entropy of the uncompressed message set.

26. The wireless device of claim 14, wherein the BPRE parameter is based at least in part on a quantity of cyclic redundancy check bits associated with the first message.

27. A method for wireless communications at a wireless device, comprising:
communicating bit distribution information for an uncompressed message set, the uncompressed message set comprising a plurality of messages and the bit distribution information indicating a distribution of bits included in one or more messages of the plurality of messages of the uncompressed message set; and
transmitting, at a transmit power determined in accordance with a bits per resource element (BPRE) parameter, a first message from the plurality of messages of the uncompressed message set, wherein the BPRE parameter is a function of the bit distribution information for the uncompressed message set and a quantity of resource elements utilized for transmission of the first message.

28. The method of claim 27, wherein the bit distribution information comprises entropy information associated with the uncompressed message set.

29. The method of claim 27, wherein the bit distribution information comprises probability information associated with a quantity of bits of the first message.

30. A method for wireless communications at a wireless device, comprising:
communicating bit distribution information for an uncompressed message set, the uncompressed message set comprising a plurality of messages and the bit distribution information indicating a distribution of bits included in one or more messages of the plurality of messages of the uncompressed message set; and
obtaining a first message from the plurality of messages of the uncompressed message set, the first message communicated at a transmit power determined in accordance with a bits per resource element (BPRE) parameter, wherein the BPRE parameter is a function of the bit distribution information for the uncompressed message set and a quantity of resource elements utilized for transmission of the first message.
